(19) United States
(12) Patent Application Publication
(10) Pub. No.: US 2026/0243944 A1
(43) Pub. Date: Aug. 20, 2026

(54) Structural Optical Film and Backlight Module

(71) Applicant: DARWIN PRECISIONS CORPORATION, Hsinchu County (TW)

(72) Inventor: HSIANG-I HU, Hsinchu County (TW)

(21) Appl. No.: 19/537,599

(22) Filed: Feb. 12, 2026

(30) Foreign Application Priority Data
Feb. 14, 2025 (TW) 114105582

(51) Int. Cl. F21V 8/00; G02F 1/1335; G02F 1/13357

(52) U.S. Cl. CPC G02B 6/0053; G02F 1/133607; G02F 1/133615

(57) ABSTRACT

A backlight module includes a structural optical film, a composite film, a brightening film, a light guide plate, and a plurality of light-emitting elements. The structural optical film includes a structural optical body and a structural layer. The structural optical body has a first light-emitting surface and a first bottom surface opposite to each other. The structural layer, disposed on the first bottom surface, includes a plurality of first strip structures and a plurality of optical diffusion structures. The first strip structures are arranged at intervals and the optical diffusion structures are disposed between the first strip structures. The composite film is disposed on the first light-emitting surface. The brightening film is disposed on the composite film. The light guide plate is arranged on the first bottom surface. The light emitting elements are arranged on one side of the light guide plate.

### FIELD OF THE INVENTION

The present invention relates to a structural optical film and an optical module, and more particularly to a structural optical film that enhances light uniformity while maintaining brightness gain and a backlight module having a concentrated viewing angle.

### BACKGROUND OF THE INVENTION

Current display devices typically use a backlight module as a light source, and therefore the light emitted from the backlight module affects the image display performance of the display device and impacts the quality of the viewing experience for the user. Backlight modules are generally classified into direct-lit and edge-lit types according to the position of the light source. In the edge-lit backlight modules, a light guide plate is typically used to convert the light emitted by the light source into a surface light source. However, existing backlight module structures still fail to effectively concentrate the light emission viewing angle, thereby affecting the image quality observed by the user when viewing the display device.

### SUMMARY OF THE INVENTION

The present invention provides a structural optical film and a backlight module. The structural optical film improves light uniformity and maintains the brightness. Thus, the backlight module with the structural optical film enables light convergence within the viewing angle, thereby enhancing brightness. In comparison with the conventional backlight modules, the present invention meets the power-saving requirements while providing the same level of brightness.

In order to achieve one, some, or all the aforementioned objectives, or other objectives, a backlight module is provided with a structural optical film, a composite film, a brightening film, a light guide plate, and a plurality of light-emitting elements. The structural optical film includes a structural optical body and a structural layer. The structural optical body includes a first light-emitting surface and a first bottom surface opposite to each other. The structural layer is disposed on the first bottom surface. The structural layer includes a plurality of first strip structures and a plurality of optical diffusion structures. The first strip structures are arranged at intervals, and the optical diffusion structures are disposed between the first strip structures, respectively. The composite film is disposed on one side of the structural optical film adjacent to the first light-emitting surface. The composite film includes a second light-emitting surface and a second bottom surface opposite to each other. The second bottom surface faces the first light-emitting surface of the structural optical film. The composite film further includes a plurality of second strip structures disposed on the second light-emitting surface and an anti-absorption layer disposed on the second bottom surface. The brightening film is disposed on one side of the composite film adjacent to the second light-emitting surface. The brightening film includes a third light-emitting surface and a third bottom surface opposite to each other. The third bottom surface faces the second light-emitting surface of the composite film. The brightening film further includes a plurality of third strip structures disposed on the third light-emitting surface. The light guide plate is disposed on one side of the composite film adjacent to the first bottom surface. The light guide plate includes a light incident surface, an upper surface, and a lower surface opposite to the upper surface. The upper surface faces the first bottom surface of the structural optical surface. The light-emitting elements are disposed on one side of the light guide plate adjacent to the light incident surface and arranged along a light source arrangement direction.

In an embodiment of the present invention, each of the first strip structures of the structural optical film extends along a first extension direction, and the first extension direction is not parallel to the light source arrangement direction.

In an embodiment of the present invention, a first extension angle is defined between the first extension direction and the light source arrangement direction. The first extension angle is between 60 degrees and 120 degrees.

In an embodiment of the present invention, each of the second strip structures extends along a second extension direction. A second extension angle is defined between the first extension direction and the second extension direction, and the second extension angle is between 80 degrees and 100 degrees.

In an embodiment of the present invention, each of the third strip structures extends along a third extension direction. A third extension angle is defined between the first extension direction and the third extension direction, and the third extension angle is between 0 degrees and 10 degrees.

In an embodiment of the present invention, each of the first strip structures includes two first side surfaces. A first structural angle is defined between the two first side surfaces, and the first structural angle is between 80 degrees and 110 degrees.

In an embodiment of the present invention, each of the first strip structures further includes a first top surface. The first top surface is connected to the two first side surfaces. The first top surface is an arc surface.

In an embodiment of the present invention, a cross-section of each of the first strip structures perpendicular to the first bottom surface is semi-elliptical, or alternatively, the cross-section of each of the first strip structures perpendicular to the first bottom surface has an edge line which is a parabola.

In an embodiment of the present invention, when the cross-section of each of the first strip structures perpendicular to the first bottom surface is semi-elliptical, an edge of the cross-section conforms to the elliptical equation

$$1 = \frac{{( x - H )}^{2}}{{A}^{2}} + \frac{{( y - K )}^{2}}{{B}^{2}} ,$$

where A is the semi-major axis length, B is the semi-minor axis length, B is less than A, H represents an X-axis coordinate of the center of the ellipse, which is an intersection of the major axis and the minor axis in the X-Y plane, K represents the Y-axis coordinate of the center of the ellipse, x represents an X-axis coordinate of an arbitrary point on the elliptical perimeter, y represents the Y-axis coordinate of the arbitrary point, and y is greater than or equal to K, or greater than or equal to zero.

In an embodiment of the present invention, when the edge line of the cross-section of each of the first strip structures perpendicular to the first bottom surface is a parabola, the edge line conforms to the parabolic equation

$${( x - h )}^{2} = 4 c ( y - k ) ,$$

where the axis of the symmetry of the parabola in the X-Y plane is x=h, the focus of the parabola is located at (h, k+c), h represents the X-axis coordinate of the vertex of the parabola in the X-Y plane, k represents the Y-axis coordinate of the vertex of the parabola in the X-Y plane, y is greater than or equal to 0, c is the focus length of the parabola, and the absolute value of c is greater than 0.1 μm and less than 5 μm.

In an embodiment of the present invention, each of the first strip structures has a first strip structure height in a direction perpendicular to the first bottom surface, and each of the optical diffusion structures has an optical diffusion structure height in the direction perpendicular to the first bottom surface. The first strip structure height is greater than the optical diffusion structure height.

In an embodiment of the present invention, each of the optical diffusion structures is a coating layer including a plurality of diffusion particles.

In an embodiment of the present invention, each of the optical diffusion structures includes a plurality of dot-shaped microstructures. Each of the dot-shaped microstructures has a surface profile. The surface profile is a spherical surface, an elliptical surface, or a free-form curved surface.

In an embodiment of the present invention, the surface profile conforms to the equation

$$S ( x ) = \frac{{x}^{2}}{R + \sqrt{{R}^{2} - ( k + 1 ) {x}^{2}}} ,$$

where S(x) represents the surface profile of each of the dot-shaped microstructures in the X-axis, k represents a conic constant of each of the dot-shaped microstructures, k is greater than −1 and less than or equal to 0, R represents a radius of curvature at a vertex of each of the dot-shaped microstructures, R is between 0.05 μm and 0.2 μm, x represents an X-axis coordinate of the surface profile, and the dot-shaped microstructures have the same R value and the same k value.

In an embodiment of the present invention, the optical diffusion structures collectively occupy between 5% and 50% of the overall area of the first bottom surface.

In an embodiment of the present invention, the structural optical film further includes a buffer layer. The buffer layer is disposed on the first light-emitting surface. The buffer layer includes a flexible optical adhesive.

In an embodiment of the present invention, the light guide plate further includes a plurality of light guide microstructures, and the light guide microstructures are disposed on the lower surface.

In an embodiment of the present invention, each of the light guide microstructures includes a backlight surface. A backlight angle is defined between the backlight surface and the lower surface. The backlight angle is between 1 degree and 6 degrees.

In an embodiment of the present invention, each of the light guide microstructures includes a light-receiving surface. A light-receiving angle is defined between the light-receiving surface and the lower surface. The light-receiving angle is between 1 degree and 20 degrees.

In an embodiment of the present invention, each of the second strip structures includes two second side surfaces. A second structural angle is defined between the two second side surfaces, and the second structural angle is between 80 degrees and 110 degrees.

In an embodiment of the present invention, each of the second strip structures further includes a second top surface, the second top surface is connected to the two second side surfaces, and the second top surface is an arc surface.

In an embodiment of the present invention, a cross-section of each of the second strip structures perpendicular to the second light-emitting surface is semi-elliptical, or alternatively, the cross-section of each of the second strip structures perpendicular to the second light-emitting surface has an edge line which is a parabola.

In an embodiment of the present invention, when the cross-section of each of the second strip structures perpendicular to the second light-emitting surface is semi-elliptical, an edge of the cross-section conforms to the elliptical equation

$$1 = \frac{{( x - H )}^{2}}{{A}^{2}} + \frac{{( y - K )}^{2}}{{B}^{2}} ,$$

where A is the semi-major axis length, B is the semi-minor axis length, B is less than A, H represents the X-axis coordinate of the center of the ellipse, which is an intersection of the major axis and the minor axis in the X-Y plane, K represents the Y-axis coordinate of the center of the ellipse, x represents an X-axis coordinate of an arbitrary point on the elliptical perimeter, y represents the Y-axis coordinate of the arbitrary point, and y is greater than or equal to K, or greater than or equal to zero.

In an embodiment of the present invention, when the edge line of the cross-section of each of the second strip structures perpendicular to the second light-emitting surface is a parabola, the edge line conforms to the parabolic equation

$${( x - h )}^{2} = 4 c ( y - k ) ,$$

where the axis of the symmetry of the parabola in the X-Y plane is x=h, the focus of the parabola is located at (h, k+c), h represents the X-axis coordinate of the vertex of the parabola in the X-Y plane, k represents the Y-axis coordinate of the vertex of the parabola in the X-Y plane, y is greater than or equal to 0, c is the focus length of the parabola, and the absolute value of c is greater than 0.1 μm and less than 5 μm.

In an embodiment of the present invention, the anti-absorption structure includes a plurality of dot-shaped microstructures. Each of the dot-shaped structures has a surface profile, and the surface profile is a spherical surface, an elliptical surface, or a free-form curved surface.

In an embodiment of the present invention, the surface profile conforms to the equation

$$S ( x ) = \frac{{x}^{2}}{R + \sqrt{{R}^{2} - ( k + 1 ) {x}^{2}}} ,$$

where S(x) represents the surface profile of each of the dot-shaped microstructures in the X-axis, k represents a conic constant of each of the dot-shaped microstructures, k is greater than −1 and less than or equal to 0, R represents a radius of curvature at a vertex of each of the dot-shaped microstructures, R is between 0.005 μm and 0.05 μm, x represents an X-axis coordinate of the surface profile, and the dot-shaped microstructures have the same R value and the same k value.

In an embodiment of the present invention, the anti-absorption structure is a coating layer including a plurality of diffusion particles.

In an embodiment of the present invention, each of the third strip structures includes two third side surfaces. A third structural angle is defined between the two third side surfaces, and the third structural angle is between 80 degrees and 110 degrees.

In an embodiment of the present invention, each of the third strip structures further includes a third top surface, the third top surface is connected to the two third side surfaces, and the third top surface is an arc surface.

In an embodiment of the present invention, a cross-section of each of the third strip structures perpendicular to the third light-emitting surface is semi-elliptical, or alternatively, the cross-section of each of the third strip structures perpendicular to the third light-emitting surface has an edge line which is a parabola.

In an embodiment of the present invention, when the cross-section of each of the third strip structures perpendicular to the third light-emitting surface is semi-elliptical, an edge of the cross-section conforms to the elliptical equation

$$1 = \frac{{( x - H )}^{2}}{{A}^{2}} + \frac{{( y - K )}^{2}}{{B}^{2}} ,$$

where A is the semi-major axis length, B is the semi-minor axis length, B is less than A, H represents the X-axis coordinate of the center of the ellipse, which is an intersection of the major axis and the minor axis in the X-Y plane, K represents the Y-axis coordinate of the center of the ellipse, x represents an X-axis coordinate of an arbitrary point on the elliptical perimeter, y represents the Y-axis coordinate of the arbitrary point, and y is greater than or equal to K, or is greater than or equal to zero.

In an embodiment of the present invention, when the edge line of the cross-section of each of the second strip structures perpendicular to the second light-emitting surface is a parabola, the edge line conforms to the parabolic equation

$${( x - h )}^{2} = 4 c ( y - k ) ,$$

where the axis of the symmetry of the parabola in the X-Y plane is x=h, the focus of the parabola is located at (h, k+c), h represents the X-axis coordinate of the vertex of the parabola in the X-Y plane, k represents the Y-axis coordinate of the vertex of the parabola in the X-Y plane, y is greater than or equal to 0, c is the focus length of the parabola, and the absolute value of c is greater than 0.1 μm and less than 5 μm.

In an embodiment of the present invention, the backlight module further includes a reflective sheet and an optical film. The reflective sheet is disposed on one side of the light guide plate adjacent to the lower surface. The optical film is disposed on one side of the structural optical film away from the light guide plate. The optical film includes a diffusion sheet or a reflective brightening film.

According to an embodiment of the present invention, a structural optical film is provided with a structural optical body and a structural layer. The structural optical body includes a first light-emitting surface and a first bottom surface opposite to each other. The structural layer is disposed on the first bottom surface. The structural layer includes a plurality of first strip structures and a plurality of optical diffusion structures. The first strip structures are arranged at intervals, and the optical diffusion structures are respectively disposed between the first strip structures.

In an embodiment of the present invention, each of the first strip structures includes two first side surfaces. A first structural angle is defined between the two first side surfaces, and the first structural angle is between 80 degrees and 110 degrees.

In an embodiment of the present invention, each of the first strip structures further includes a first top surface. The first top surface is connected to the two first side surfaces. The first top surface is an arc surface.

In an embodiment of the present invention, a cross-section of each of the first strip structures perpendicular to the first bottom surface is semi-elliptical, or alternatively, the cross-section of each of the first strip structures perpendicular to the first bottom surface has an edge line which is a parabola.

In an embodiment of the present invention, each of the first strip structures has a first strip structure height in a direction perpendicular to the first bottom surface, and each of the optical diffusion structures has an optical diffusion structure height in the direction perpendicular to the first bottom surface. The first strip structure height is greater than the optical diffusion structure height.

In an embodiment of the present invention, each of the optical diffusion structures is a coating layer including a plurality of diffusion particles.

In an embodiment of the present invention, each of the optical diffusion structures includes a plurality of dot-shaped microstructures. Each of the dot-shaped microstructures has a surface profile. The surface profile is a spherical surface, an elliptical surface, or a free-form curved surface.

By utilizing a combination of a structural optical film and a light guide plate, the present invention enables the backlight module to achieve light viewing angle convergence while enhancing overall brightness. In addition, the composite film and the brightening film further improve the overall output efficiency of the backlight module under the condition of light viewing angle convergence. In comparison with the conventional backlight modules, the present invention meets the requirement of lower power consumption while maintaining the same brightness level.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic side view of a backlight module according to an embodiment of the present invention.

FIG. 2 is a schematic bottom view of a structural optical film according to an embodiment of the present invention.

FIG. 3 is a schematic side view of a first strip structure of a structural optical film according to an embodiment of the present invention.

FIG. 4 is a schematic side view of a structural optical film according to another embodiment of the present invention.

FIG. 5 is a schematic diagram of a cross-section of a first strip structure in a planar coordinate system according to another embodiment of the present invention.

FIG. 6 is a schematic diagram of a cross-section of a first strip structure in a planar coordinate system according to another embodiment of the present invention.

FIG. 7 is a schematic diagram of a surface profile of a dot-shaped microstructure of the structural optical film according to an embodiment of the present invention.

FIG. 8 is a side, enlarged view of a light guide plate according to an embodiment of the present invention.

FIG. 9 is a side, enlarged view of a light guide plate according to another embodiment of the present invention.

FIG. 10 is a side, enlarged view of a light guide plate according to another embodiment of the present invention.

FIG. 11 is a schematic top view of a light guide microstructure of a light guide plate according to an embodiment of the present invention.

FIG. 12 is a schematic top view of a composite film according to an embodiment of the present invention.

FIG. 13 is a schematic side view of a composite film according to an embodiment of the present invention.

FIG. 14 is a schematic side view of a second strip structure of a composite film according to an embodiment of the present invention.

FIG. 15 is a schematic top view of a brightening film according to an embodiment of the present invention.

FIG. 16 is a schematic side view of a third strip structure of a brightening film according to an embodiment of the present invention.

FIG. 17 is a schematic side view of a backlight module according to another embodiment of the present invention.

### DETAILED DESCRIPTION OF PREFERRED EMBODIMENTS

In the following description of embodiments according to the present invention, terms indicating orientation or positional relationships, such as “upper,” “lower,” etc., are described based on the orientation or positional relationships shown in the corresponding drawings. These terms are used solely for the convenience of describing the invention and are not intended to limit the invention or to imply that the referenced elements must have a particular orientation or be constructed in a particular orientation. Furthermore, the terms “first,” “second,” and the like, as used in this specification or the claims, are employed merely to designate names of elements or to distinguish between different embodiments or ranges and are not intended to limit the number of elements. Unless limited otherwise, the terms “connected” or “coupled” as used in this specification or the claims may refer to either a direct connection between two elements without the presence of other elements or an indirect connection through the presence of other elements.

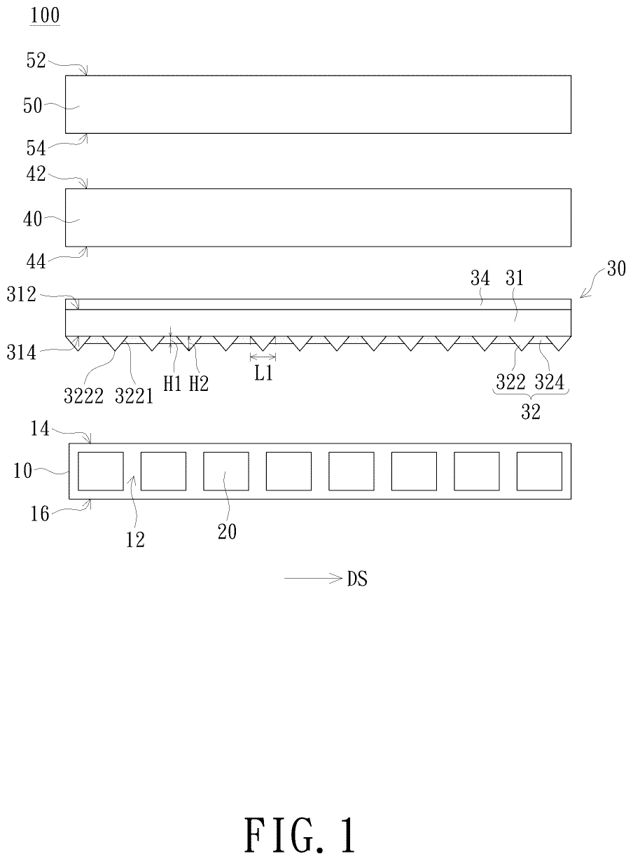

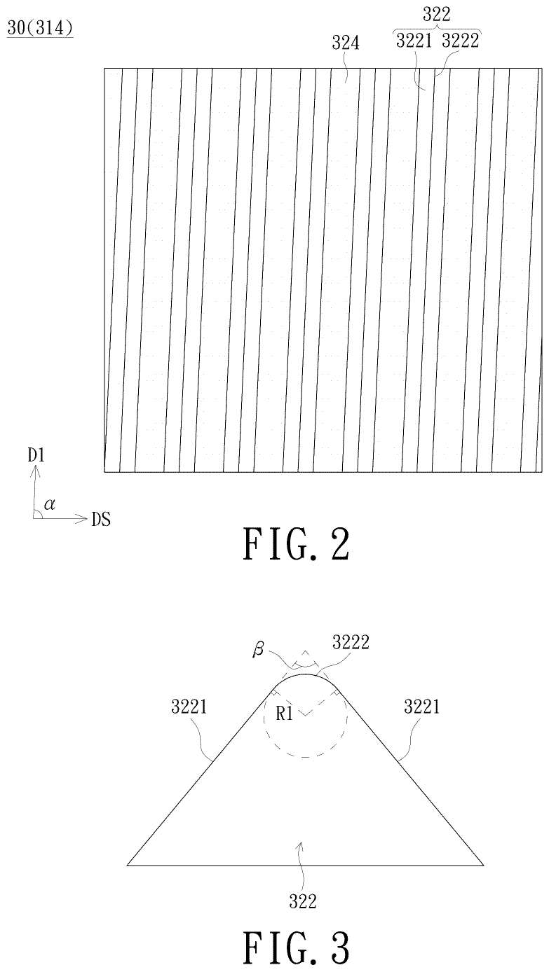

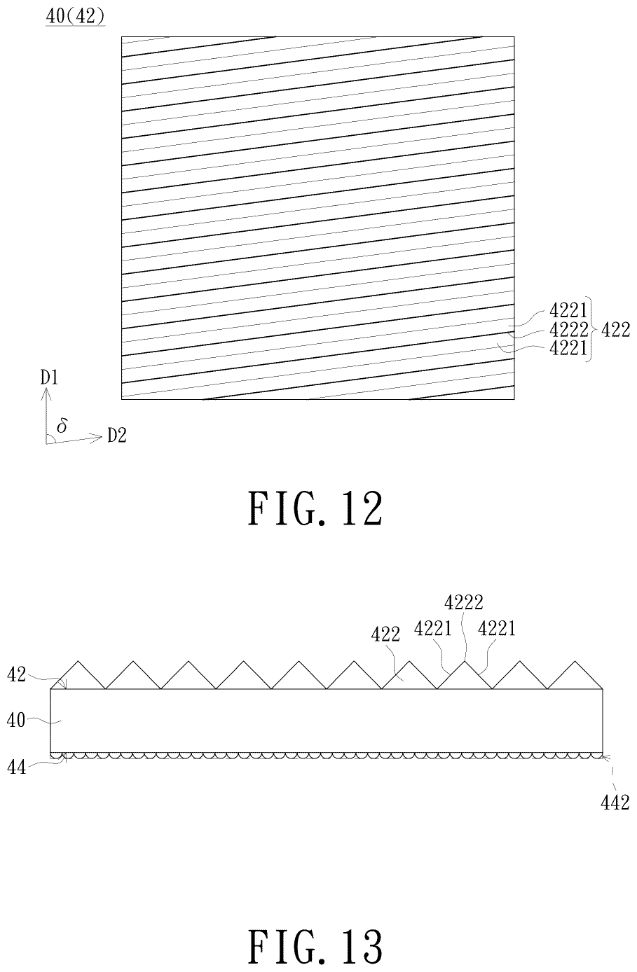

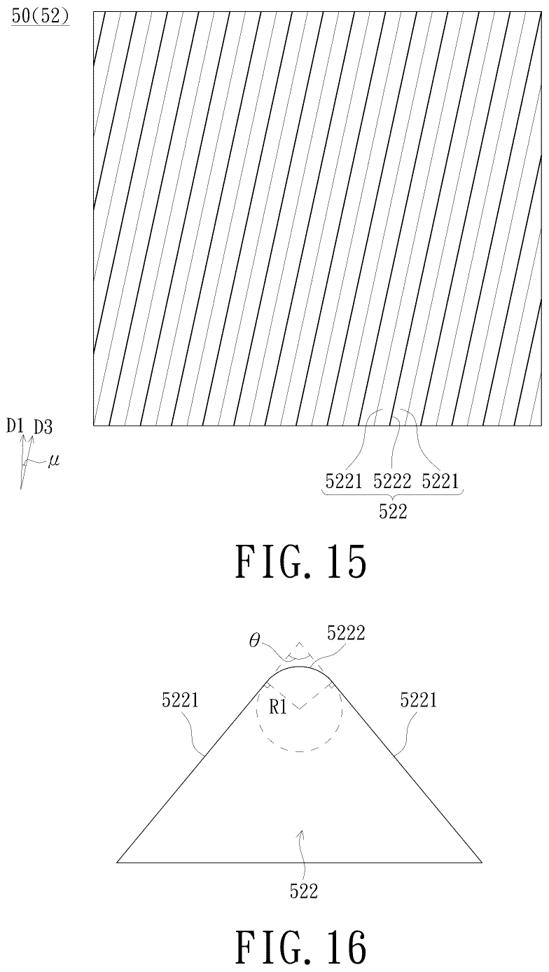

FIG. 1 is a schematic side view of a backlight module according to an embodiment of the present invention. FIG. 2 is a schematic bottom view of a structural optical film according to an embodiment of the present invention. As shown in FIG. 1 and FIG. 2, a backlight module 100 includes a structural optical film 30, a composite film 40, a brightening film 50, a light guide plate 10, and a plurality of light-emitting elements 20. The structural optical film 30 includes a structural optical body 31 and a structural layer 32. The structural optical body 31 includes a first light-emitting surface 312 and a first bottom surface 314 opposite to each other. The structural layer 32 is disposed on the first bottom surface 314. The structural layer 32 includes a plurality of first strip structures 322 and a plurality of optical diffusion structures 324. The first strip structures 322 are arranged at intervals, and each of the first strip structures 322 extends along a first extension direction D1 (as shown in FIG. 2). The optical diffusion structures 324 are disposed between the first strip structures 322 to enable the backlight module 100 to output light beams uniformly. The composite film 40 is disposed on one side of the structural optical film 30 adjacent to the first light-emitting surface 312. The composite film 40 includes a second light-emitting surface 42 and a second bottom surface 44 opposite to each other. The second bottom surface 44 faces the first light-emitting surface 312 of the structural optical film 30. The composite film 40 further includes a plurality of second strip structures 422 (illustrated in FIG. 12 and FIG. 13) disposed on the second light-emitting surface 42 and an anti-absorption layer 442 (illustrated in FIG. 13) disposed on the second bottom surface 44. The brightening film 50 is disposed on one side of the composite film 40 adjacent to the second light-emitting surface 42. The brightening film 50 includes a third light-emitting surface 52 and a third bottom surface 54 opposite to each other. The third bottom surface 54 faces the second light-emitting surface 42 of the composite film 40. The brightening film 50 further includes a plurality of third strip structures 522 (illustrated in FIG. 15) on the third light-emitting surface 52. The light guide plate 10 is disposed on one side of the structural optical film 30 adjacent to the first bottom surface 314. The light guide plate 10 includes a light incident surface 12, an upper surface 14, and a lower surface 16 opposite to the upper surface 14. The upper surface 14 faces the first bottom surface 314 of the structural optical film 30 or the structural layer 32. The light-emitting elements 20 are disposed on one side of the light guide plate 10 adjacent to the light incident surface 12. The light-emitting elements 20 are arranged along a light source arrangement direction DS. The first extension direction D1 and the light source arrangement direction DS are not parallel to each other. In an embodiment, a first extension angle α is defined between the first extension direction D1 and the light source arrangement direction DS. The first extension angle α is between 60 degrees and 120 degrees, such as 60 degrees, 65 degrees, 70 degrees, 75 degrees, 80 degrees, 85 degrees, 90 degrees, 95 degrees, 100 degrees, 105 degrees, 110 degrees, 115 degrees, and 120 degrees. If Moiré interference occurs due to the interaction between the prism structure and the pixel pitch of the liquid crystal display, this phenomenon can be mitigated by adjusting the first extension angle α within the range. In one embodiment, the first extension angle α is between 80 degrees and 100 degrees, which provides optimal brightness enhancement.

Following the above descriptions, FIG. 3 is a schematic side view of the first strip structure according to an embodiment of the present invention. Please refer to FIG. 1 and FIG. 3. The first strip structures 322 protrude from the first bottom surface 314. Each of the first strip structures 322 includes two first side surfaces 3221. A first structural angle β is defined between the two first side surfaces 3221, though the invention is not limited thereto. Specifically, the two first side surfaces 3221 may be connected directly through their top edges, or alternatively, the top edges of the two first side surfaces 3221 are connected through a first top surface 3222. The first top surface 3222 may be, for example, a curved surface, a single planar surface, or a plurality of planar surfaces. The curved surface may include, but is not limited to, an arc surface. The single planar surface may be parallel to the first bottom surface 314 or not parallel to the first bottom surface 314. The plurality of planar surfaces are connected sequentially, and none of the planar surfaces is parallel to either of the two first side surfaces 3221. When the two first side surfaces 3221 are connected through their top edges, the first structural angle β defined between the two first side surfaces 3221 is a top corner of the first strip structure 322. When the top edges of the two first side surfaces 3221 are connected through the first top surface 3222, the two first side surfaces 3221 extend along directions away from the first bottom surface 314 and intersect each other to define the first structural angle β. The first structural angle β is an imaginary angle formed either outside the first strip structure 322 or inside the first strip structure 322. The first structural angle β is between 80 degrees and 110 degrees, for example, but not limited to 80 degrees, 82.5 degrees, 85 degrees, 87.5 degrees, 90 degrees, 92.5 degrees, 95 degrees, 97.5 degrees, 100 degrees, 102.5 degrees, 105 degrees, 107.5 degrees, and 110 degrees.

Furthermore, take the first strip structure 322 illustrated in FIG. 3 as an example in which the two first side surfaces 3221 are connected through the first top surface 3222, that is, the first strip structure 322 further includes the first top surface 3222 connected to the two first side surfaces 3221. In an embodiment, as shown in FIG. 3, when the first top surface 3222 is an arc surface, a cross-sectional view of the first stripe structure 322 perpendicular to the first bottom surface 314 reveals that the first stripe structure 322 is at least defined by the first bottom surface 314, the two first side surfaces 3221, and a rounded corner (R corner). The radius of curvature R1 of the rounded corner is greater than 0 μm and less than or equal to 20 μm, for example, but not limited to 1 μm, 2.5 μm, 5 μm, 7.5 μm, 10 μm, 12.5 μm, 15 μm, 17.5 μm, and 20 μm.

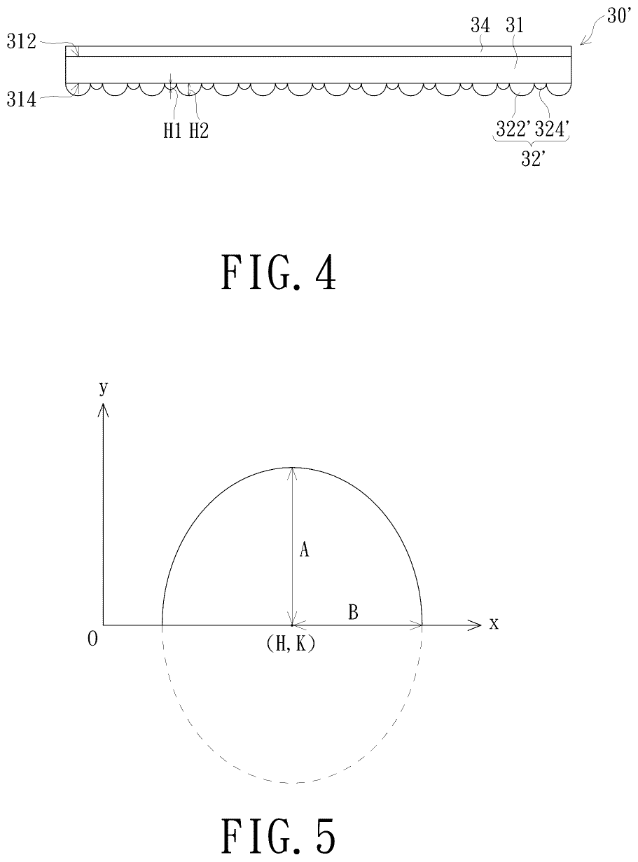

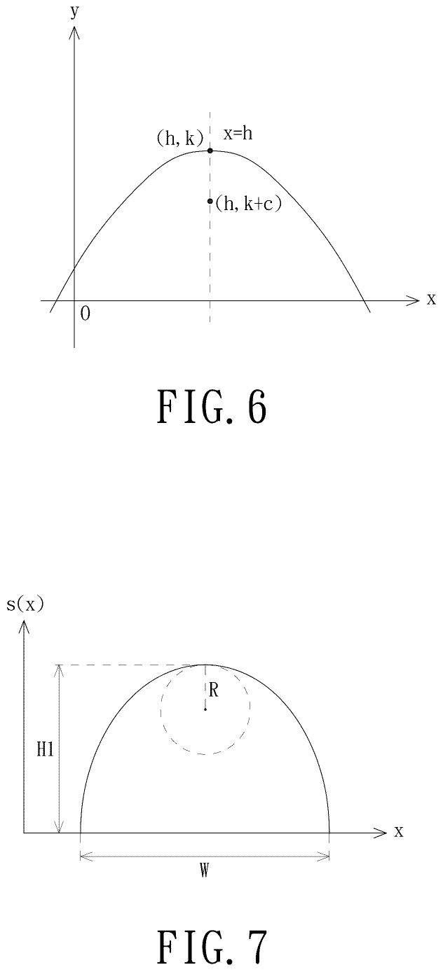

Referring to the foregoing description, FIG. 4 is a schematic side view of a structural optical film according to another embodiment of the present invention. FIG. 5 is a schematic diagram of a cross-section of a first strip structure of the structural optical film in a planar coordinate system according to another embodiment of the present invention. FIG. 6 is a schematic diagram of a cross-section of a first strip structure of the structural optical film in a planar coordinate system according to another embodiment of the present invention. As shown in FIG. 4, a structural optical film 30′ includes a structural optical body 31 and a structural layer 32′. The structural layer 32′ includes a plurality of first strip structures 322′ and a plurality of optical diffusion structures 324′. The main differences between the structural optical film 30′ and the structural optical film 30 are that the cross-sectional shape of the first strip structure 322′ and the form of the optical diffusion structures 324′ are different from the cross-sectional shape of the first strip structure 322 and the form of the optical diffusion structures 324. The differences will be described in detail in the following paragraphs.

Continuing from the above, each of the first strip structures 322/322′ has a first strip structure height H2 in a direction perpendicular to the first bottom surface 314. Each of the optical diffusion structures 324/324′ has an optical diffusion structure height H1 in the direction perpendicular to the first bottom surface 314. The first strip structure height H2 is greater than the optical diffusion structure height H1, thereby preventing the optical diffusion structures 324 from directly contacting the light guide plate 10, which helps to avoid abrasion of the light guide plate 10. In one embodiment, the optical diffusion structure height H1 is between 5 μm and 30 μm, for example, but not limited to 5 μm, 10 μm, 15 μm, 20 μm, 25 μm, and 30 μm. The first strip structure height H2 is between 10 μm and 50 μm, for example, but not limited to 10 μm, 15 μm, 20 μm, 25 μm, 30 μm, 35 μm, 40 μm, 45 μm, and 50 μm. Alternatively, the cross-section of the first strip structure 322/322′ perpendicular to the first bottom surface 314 includes a bottom edge. A length L1 of the bottom edge is between 20 μm and 100 μm, for example, but not limited to 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, and 100 μm. In an embodiment, as shown in FIG. 1, the structural optical film 30 further includes a buffer layer 34. The buffer layer 34 is disposed on the first light-emitting surface 312 of the structural optical body 31. The second bottom surface 44 of the composite film 40 faces the buffer layer 34. The buffer layer 34 includes, for example, a flexible optical adhesive. The invention is not limited thereto.

Please refer to FIG. 3 to FIG. 5. In comparison with the first strip structure 322, which includes the two first side surfaces 3221 and has a cross-section perpendicular to the first bottom surface 314 that is triangular or a triangle with rounded corners, the first strip structure 322′ has a cross-section perpendicular to the first bottom surface 314 that is, for example, semi-elliptical, though the invention is not limited thereto. An edge of the cross-section conforms to the elliptical equation

$$1 = \frac{{( x - H )}^{2}}{{A}^{2}} + \frac{{( y - K )}^{2}}{{B}^{2}} ,$$

where A is the semi-major axis length, B is the semi-minor axis length, B is less than A, H represents an X-axis coordinate of the center of the ellipse, which is an intersection of the major axis and the minor axis in the X-Y plane, K represents the Y-axis coordinate of the center of the ellipse, x represents an X-axis coordinate of an arbitrary point on the elliptical perimeter, y represents the Y-axis coordinate of the arbitrary point, and y is greater than or equal to K, or greater than or equal to zero. In an embodiment, A is greater than 15 μm and less than 30 μm, for example, but not limited to 15 μm, 17.5 μm, 20 μm, 22.5 μm, 25 μm, 27.5 μm, and 30 μm. B is greater than 10 μm and less than 25 μm, for example, but not limited to 10 μm, 12.5 μm, 15 μm, 17.5 μm, 20 μm, 22.5 μm, and 25 μm. Alternatively, as shown in FIG. 6, an edge line of the cross-section of the first strip structure 322′ perpendicular to the first bottom surface 314 is a parabola. The edge line conforms to the parabolic equation

$${( x - h )}^{2} = 4 c ( y - k ) ,$$

where the axis of the symmetry of the parabola in the X-Y plane is x=h, the focus of the parabola is located at (h, k+c), h represents the X-axis coordinate of the vertex of the parabola in the X-Y plane, k represents the Y-axis coordinate of the vertex of the parabola in the X-Y plane, y is greater than or equal to 0, c is the focus length of the parabola, and the absolute value of c is greater than 0.1 μm and less than 5 μm.

Each of the optical diffusion structures 324 disposed between the two adjacent first strip structures 322 may be a coating layer including a plurality of diffusion particles. Each of the optical diffusion structures 324′ disposed between the two adjacent first strip structures 322′ may include a plurality of dot-shaped microstructures. However, the invention is not limited thereto. Please refer to FIG. 1 and FIG. 2. The optical diffusion structure 324 is a coating layer disposed between two of the adjacent first strip structures 322. The coating layer includes a plurality of diffusion particles. In an embodiment, the coating layer may cover the first bottom surface 314 or cover the first bottom surface 314 and a plurality of dot-shaped microstructures.

FIG. 7 is a schematic diagram of a surface profile of a dot-shaped microstructure of the structural optical film according to an embodiment of the present invention. Please refer to FIG. 4 and FIG. 7. The optical diffusion structure 324′ disposed between two of the adjacent first strip structures 322′ includes a plurality of dot-shaped microstructures. The dot-shaped microstructure has a surface profile, for example, but not limited to a spherical surface, an elliptical surface, or a free-form curved surface. In addition, the surface profile conforms to the equation

$$S ( x ) = \frac{{x}^{2}}{R + \sqrt{{R}^{2} - ( k + 1 ) {x}^{2}}} ,$$

where S(x) represents the surface profile of each of the dot-shaped microstructures in the X-axis. k represents a conic constant of each of the dot-shaped microstructures, and k is greater than −1 and less than or equal to 0. R represents a radius of curvature at a vertex of each of the dot-shaped microstructures, and R is between 0.05 μm and 0.2 μm. x represents an X-axis coordinate of the surface profile, and a difference between a maximum and a minimum of x is W. In other words, W is a width of the dot-shaped microstructure, and W is between 5 μm and 50 μm, for example, but not limited to 5 μm, 10 μm, 20 μm, 30 μm, 40 μm, and 50 μm. Each of the dot-shaped microstructures has the same R value and the same k value. In an embodiment, the optical diffusion structures 324, each of which is located between two of the adjacent first strip structures 322, collectively occupy between 5% and 50% of the overall area of the first bottom surface 314.

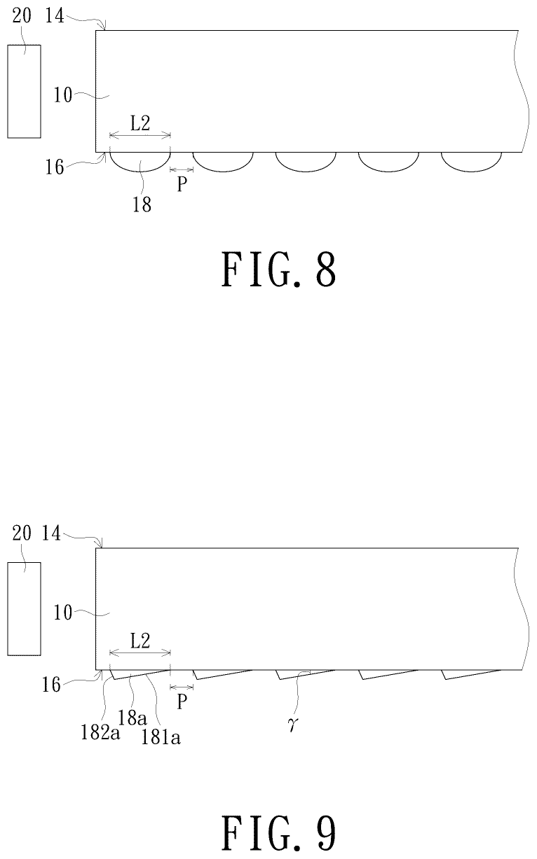

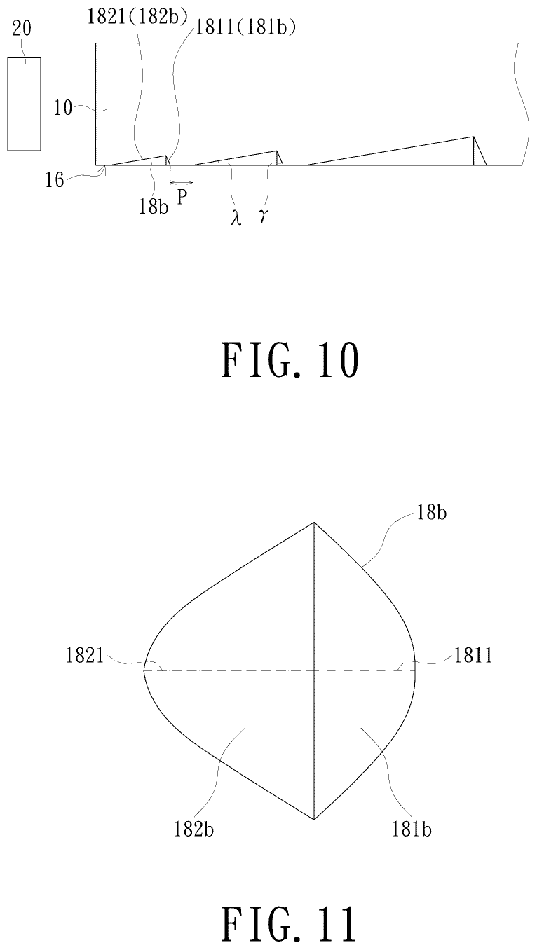

In the embodiment illustrated in FIG. 1, the lower surface 16 of the light guide plate 10 is illustrated as a plain surface though the invention is not limited thereto. The light guide plate 10 may be, for example, a high-directionality light guide plate. FIG. 8 is a side, enlarged view of a light guide plate according to an embodiment of the present invention. FIG. 9 is a side, enlarged view of a light guide plate according to another embodiment of the present invention. FIG. 10 is a side, enlarged view of a light guide plate according to another embodiment of the present invention. Please refer to FIG. 8 to FIG. 10. The light guide plate 10 further includes a plurality of light guide microstructures 18/18a/18b. The invention is not limited thereto. The light guide microstructures 18/18a/18b are disposed on the lower surface 16. An interval P may be defined between two of the adjacent light guide microstructures 18. The light guide microstructures 18/18a/18b may be arc structures, V-cut structures, or fly-cut structures. The invention is not limited thereto. In an embodiment, a plurality of laser dots are disposed on the lower surface 16 of the light guide plate 10.

As shown in FIG. 8, when the light guide microstructures 18 are arc structures, the light guide microstructures 18 protrude from the lower surface 16 and are arranged in an array. As shown in FIG. 9, when the light guide microstructures 18a are V-cut structures, the light guide microstructures 18a protrude from the lower surface 16 and are arranged in an array. Each of the light guide microstructures 18a includes a backlight surface 181a and a light-receiving surface 182a. The light-receiving surface 182a of each of the light guide microstructures 18a is located between the light-emitting elements 20 and the backlight surface 181a. A backlight angle γ is defined between the backlight surface 181a and the lower surface 16, and the backlight angle γ is between 1 degree and 6 degrees, for example, but not limited to 1 degree, 1.5 degrees, 2 degrees, 2.5 degrees, 3 degrees, 3.5 degrees, 4 degrees, 4.5 degrees, 5 degrees, 5.5 degrees, and 6 degrees.

FIG. 11 is a schematic top view of a light guide microstructure of a light guide plate according to an embodiment of the present invention. As shown in FIG. 10 and FIG. 11, when the light guide microstructures 18b are fly-cut structures, the light guide microstructures 18b are recessed on the lower surface 16 of the light guide plate 10. The light guide microstructures 18b include a backlight surface 181b and a light-receiving surface 182b. The light-receiving surface 182b of each of the light guide microstructures 18b is located between the light-emitting elements 20 and the backlight surface 181b. The backlight surface 181b and the light-receiving surface 182b are both curved surfaces. As shown in FIG. 10, as a distance between the light-emitting elements 20 and the light guide microstructure 18b increases, the light guide microstructure 18b has a larger size. The invention is not limited thereto. A cross-section of the light guide microstructure 18b perpendicular to the lower surface 16 includes a backlight ridge line 1811 and a light-receiving ridge line 1821. The backlight ridge line 1811 refers to the most protruding edge line of the backlight surface 181b in a side view. A backlight angle γ is defined between the backlight ridge line 1811 and the lower surface 16. The light-receiving ridge line 1821 refers to the most protruding edge line of the light-receiving surface 182b in a side view. A light-receiving angle A is defined between the light-receiving ridge line 1821 and the lower surface 16. The light-receiving angle λ is less than the backlight angle γ. In an embodiment, the light-receiving angle λ is between 1 degree and 20 degrees, for example, but is not limited to 1 degree, 2 degrees, 3 degrees, 4 degrees, 5 degrees, 6 degrees, 7 degrees, 8 degrees, 9 degrees, 10 degrees, 11 degrees, 12 degrees, 13 degrees, 14 degrees, 15 degrees, 16 degrees, 17 degrees, 18 degrees, 19 degrees, and 20 degrees. In one embodiment not illustrated, as the distance between the light-emitting elements 20 and the light guide microstructures 18/18a/18b increases, the interval P between two of the adjacent light guide microstructures 18/18a/18b becomes less, that is, the light guide microstructures 18/18a/18b are arranged more densely. In an embodiment, a cross-section of each of the light guide microstructures 18/18a/18b perpendicular to the lower surface 16 has a bottom edge. A length L2 of the bottom edge is between 20 μm and 100 μm, for example, but is not limited to 20 μm, 30 μm, 40 μm, 50 μm, 60 μm, 70 μm, 80 μm, 90 μm, and 100 μm.

FIG. 12 is a schematic top view of a composite film according to an embodiment of the present invention. FIG. 13 is a schematic side view of a composite film according to an embodiment of the present invention. In the embodiment illustrated in FIG. 1, the second light-emitting surface 42 and the second bottom surface 44 of the composite film 40 are exemplified as flat surfaces, though the composite film 40 is not limited thereto. As shown in FIG. 12 and FIG. 13, the second strip structures 422 of the composite film 40 protrude from the second light-emitting surface 42, and the anti-absorption layer 442 is disposed on the second bottom surface 44. The second strip structures 422 extend along a second extension direction D2. A second extension angle δ is defined between the second extension direction D2 and the first extension direction D1. The invention is not limited thereto. In an embodiment, the second extension angle δ is between 80 degrees and 100 degrees, for example, but is not limited to 80 degrees, 81 degrees, 82 degrees, 83 degrees, 84 degrees, 85 degrees, 86 degrees, 87 degrees, 88 degrees, 89 degrees, 90 degrees, 91 degrees, 92 degrees, 93 degrees, 94 degrees, 95 degrees, 96 degrees, 97 degrees, 98 degrees, 99 degrees, and 100 degrees.

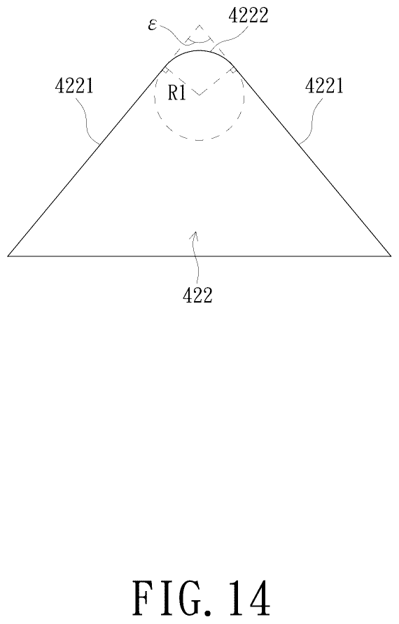

FIG. 14 is a schematic side view of a second strip structure of a composite film according to an embodiment of the present invention. As shown in FIG. 12 to FIG. 14, the second strip structures 422 are similar to the first strip structure 322. Each of the second strip structures 422 includes two second side surfaces 4221. A second structural angle ε is defined between the two second side surfaces 4221 though the invention is not limited thereto. Specifically, the two side surfaces 4221 may be connected directly through top edges of the two second side surfaces 4221, or alternatively, the two second side surfaces 4221 may be connected through a second top surface 4222. Each of the second strip structures 422 is arranged densely and closely to the adjacent second strip structures 422. When the second strip structures 422 are provided with the second top surfaces 4222, each of the second top surfaces 4222 may be, for example, a curved surface, a single planar surface, or a plurality of planar surfaces. The curved surface may include, but is not limited to, an arc surface. The single planar surface may be parallel to the second light-emitting surface 42 or not parallel to the second light-emitting surface 42. The plurality of planar surfaces are connected sequentially, and none of the planar surfaces is parallel to either of the two second side surfaces 4221. When the two second side surfaces 4221 are connected directly through their top edges, the second structural angle ε defined between the two second side surfaces 4221 is a top corner of the second strip structure 422. When the top edges of the two second side surfaces 4221 are connected through the second top surface 4222, the two second side surfaces 4221 extend along directions away from the second light-emitting surface 42 and intersect each other to define the second structural angle ε. The second structural angle ε is an imaginary angle formed either outside the second strip structure 422 or inside the second strip structure 422. The second structural angle ε is between 80 degrees and 110 degrees, for example, but not limited to 80 degrees, 82.5 degrees, 85 degrees, 87.5 degrees, 90 degrees, 92.5 degrees, 95 degrees, 97.5 degrees, 100 degrees, 102.5 degrees, 105 degrees, 107.5 degrees, and 110 degrees.

Furthermore, taking the second strip structures 422 in FIG. 14 as an example, the two second side surfaces 4221 are connected through the second top surface 4222, that is, the second strip structure 422 further includes the second top surface 4222, and the second top surface 4222 is connected between the two second side surfaces 4221. When the second top surface 4222 is an arc surface, in a cross-sectional view of the second strip structure 422 perpendicular to the second light-emitting surface 42, the second strip structure 422 may be at least defined by the second light-emitting surface 42, the two second side surfaces 4221, and a rounded corner (R corner). A definition of the rounded corner of the second strip structure 422 may refer to the rounded corner of the first strip structure 322, and no redundant detail is to be given herein.

Alternatively, the second strip structures 422 may be similar to the first strip structures 322′. As shown in FIG. 5 and FIG. 6, when the second strip structures 422 are similar to the first strip structures 322′, a cross-section of the second strip structure 422 perpendicular to the second light-emitting surface 42 may be, for example, a semi-elliptical shape, or alternatively, an edge line of the cross-section of the second strip structure 422 perpendicular to the second light-emitting surface 42 is a parabola. However, the invention is not limited thereto. The definitions of the semi-elliptical shape and the parabola may refer to the descriptions of the first strip structures 322′, and no redundant detail is to be given herein.

The anti-absorption layer 422 includes a plurality of dot-shaped microstructures though the invention is not limited thereto. Each of the dot-shaped structures has a surface profile, and the surface profile is a spherical surface, an elliptical surface, or a free-form curved surface. The surface profile conforms to the equation

$$S ( x ) = \frac{{x}^{2}}{R + \sqrt{{R}^{2} - ( k + 1 ) {x}^{2}}} ,$$

where S(x) represents the surface profile of each of the dot-shaped microstructures in the X-axis. k represents a conic constant of each of the dot-shaped microstructures, and k is greater than −1 and less than or equal to 0. R represents a radius of curvature at a vertex of each of the dot-shaped microstructures, and R is between 0.005 μm and 0.05 μm, for example, but is not limited to 0.01 μm, 0.015 μm, 0.02 μm, 0.025 μm, 0.03 μm, 0.035 μm, 0.04 μm, 0.045 μm, and 0.05 μm. x represents an X-axis coordinate of the surface profile, and a difference between a maximum and a minimum of x is W. In other words, W is a width of the dot-shaped microstructure, and W is between 10 μm and 200 μm, for example, but not limited to 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, and 200 μm. Each of the dot-shaped microstructures has the same R value and the same k value. In an embodiment not illustrated, the dot-shaped microstructures of the anti-absorption layer 442 have a height between 10 μm and 50 μm, for example, but not limited to 10 μm, 15 μm, 20 μm, 25 μm, 30 μm, 35 μm, 40 μm, 45 μm, and 50 μm.

In addition, the anti-absorption layer 442 may be a coating layer including a plurality of diffusion particles. The coating layer covers the second bottom surface 44 or covers the second bottom surface 44 and the dot-shaped microstructures. The anti-absorption layer 442 may enhance an effect of anti-static absorption. In an embodiment, the anti-absorption layer 442 is disposed between the composite film 40 and the buffer layer 34. The buffer layer 34 may reduce the abrasion between the dot-shaped microstructures of the anti-absorption layer 442 or the diffusion particles in the coating layer and the structural optical film 30, thereby reducing damages to the structural optical film 30 and extending an operation life of the structural optical film 30.

In the embodiment illustrated in FIG. 1, the third light-emitting surface 52 of the brightening film 50 is, for example, a planar surface. However, the brightening film 50 is not limited thereto. The third bottom surface 54 faces the second light-emitting surface 42 or the second strip structures 422 of the composite film 40. FIG. 15 is a schematic top view of a brightening film according to an embodiment of the present invention. As shown in FIG. 15, the brightening film 50 includes a plurality of third strip structures 522 on the third light-emitting surface 52. The third strip structures 522 protrude from the third light-emitting surface 52 and extend along a third extension direction D3. A third extension angle μ is defined between the third extension direction D3 and the first extension direction D1, and the third extension angle μ is between 0 degrees and 10 degrees.

FIG. 16 is a schematic side view of a third strip structure of a brightening film according to an embodiment of the present invention. As shown in FIG. 16, the third strip structures 522 are similar to the first strip structures 322. Each of the third strip structures 522 includes two third side surfaces 5221. A third structural angle θ is defined between the two third side surfaces 5221. Specifically, the third side surfaces 5221 may be connected directly through respective top edges of the two third side surfaces 5221, or alternatively, the two third side surfaces 5221 may be connected through a third top surface 5222. Each of the third strip structures 522 is arranged densely and closely to the adjacent third strip structures 522. When the third strip structures 522 are provided with the third top surfaces 5222, each of the third top surfaces 5222 may be, for example, a curved surface, a single planar surface, or a plurality of planar surfaces. The curved surface may include, but is not limited to, an arc surface. The single planar surface may be parallel to the third light-emitting surface 52 or not parallel to the third light-emitting surface 52. The plurality of planar surfaces are connected sequentially, and each of the planar surfaces is not parallel to the two third side surfaces 5221. When the two third side surfaces 5221 are connected directly through their top edges, the third structural angle θ defined between the two third side surfaces 5221 is a top corner of the third strip structure 522. When the top edges of the two third side surfaces 5221 are connected through the third top surface 5222, the two third side surfaces 5221 extend along directions away from the third light-emitting surface 52 and intersect each other to define the third structural angle θ. The third structural angle θ is an imaginary angle formed either outside the third strip structure 522 or inside the third strip structure 522. The third structural angle θ is between 80 degrees and 110 degrees, for example, but not limited to 80 degrees, 82.5 degrees, 85 degrees, 87.5 degrees, 90 degrees, 92.5 degrees, 95 degrees, 97.5 degrees, 100 degrees, 102.5 degrees, 105 degrees, 107.5 degrees, and 110 degrees.

When the two third side surfaces 5221 are connected through a curved surface, the third strip structure 522 includes the third top surface 5222, and the third top surface 5222 is connected between the two third side surfaces 5221. The third top surface 5222 is an arc surface though the invention is not limited thereto. As shown in FIG. 16, a cross-section of the third strip structure 522 may be at least defined by the third light-emitting surface 52, the two third side surfaces 5221, and a rounded corner (R corner). The definition of the rounded corner of the third strip structure 522 may refer to the definition of the rounded corner of the first strip structure 322, and no redundant detail is to be given herein.

Alternatively, the third strip structures 522 are similar to the first strip structures 322′. As shown in FIG. 5 and FIG. 6, when the third strip structures 522 are similar to the first strip structures 322′, the cross-section of the third strip structure 422 perpendicular to the third light-emitting surface 52 may be, for example, a semi-elliptical shape, or alternatively, an edge line of the cross-section of the third strip structure 422 perpendicular to the third light-emitting surface 52 may be a parabola. However, the invention is not limited thereto. The definition of the semi-elliptical shape and the parabola may refer to the description of the first strip structure 322′, and no redundant detail is to be given herein.

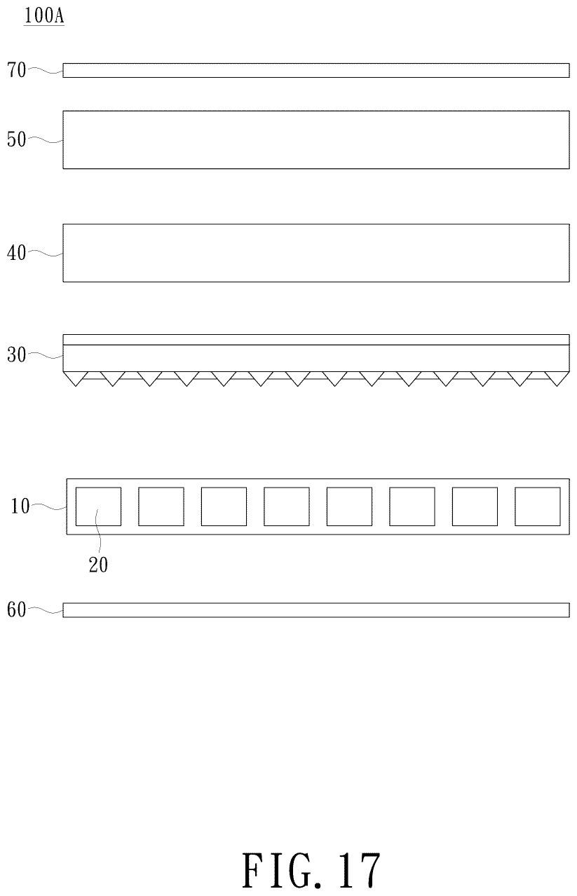

FIG. 17 is a schematic side view of a backlight module according to another embodiment of the present invention. As shown in FIG. 17, a backlight module 100A includes a structural optical film 30, a light guide plate 10, a plurality of light-emitting elements 20, a composite film 40, a brightening film 50, a reflective sheet 60, and at least one optical film 70. In comparison with the backlight module 100, the backlight module 100A further includes the reflective sheet 60 and the at least one optical film 70. The reflective sheet 60 is disposed on one side of the light guide plate 10 away from the structural optical film 30, which is the side adjacent to the lower surface 16. The optical film 70 is disposed on one side of the structural optical film 30 away from the light guide plate 10. The optical film 70 may be disposed between the structural optical film 30 and the composite film 40, between the composite film 40 and the brightening film 50, or on one side of the brightening film 50 away from the structural optical film 30. In an embodiment, the optical film 70 includes a diffusion sheet or a reflective brightening film. The reflective sheet 60 includes a white reflective sheet or a silver reflective sheet.

Generally speaking, conventional high-brightness backlight modules use silver reflective sheets, which provide higher overall brightness output than using white reflective sheets. However, the silver reflective sheets are more expensive than the white reflective sheets and provide limited light-view angle convergence. The present invention utilizes the structural optical film including the first strip structures and optical diffusion structures to enhance the light uniformity after transmission and reduce the abrasion between the light guide plate and the structural optical film. In addition, the first strip structures extend along the first extension direction, which helps prevent Moiré interference with the pixel pitch of the liquid crystal display while maintaining the brightness enhancement. When the backlight module of the present invention includes a high-directionality light guide plate, it can achieve a converged light-view angle and improve the overall light output brightness. By further combining the composite film and the brightening film, the overall light output efficiency of the backlight module may be improved even under the converged light-view angle. In other words, when the backlight module of the present invention uses the white reflective sheet, its overall light output brightness may be comparable to the overall light output brightness of the conventional high-brightness backlight module using the silver reflective sheet, while providing better light-view angle convergence and thereby meeting energy-saving requirements under the same brightness conditions. Furthermore, if a silver reflective sheet is used in the backlight module of the present invention, the overall light output brightness can exceed that of conventional high-brightness backlight modules, resulting in a better visual performance at the same power consumption.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A backlight module, comprising:
a structural optical film, comprising a structural optical body and a structural layer, wherein the structural optical body comprises a first light-emitting surface and a first bottom surface opposite to each other, the structural layer is disposed on the first bottom surface, the structural layer comprises a plurality of first strip structures and a plurality of optical diffusion structures, the first strip structures are arranged at intervals, and the optical diffusion structures are disposed between the first strip structures, respectively;
a composite film, disposed on one side of the structural optical film adjacent to the first light-emitting surface, wherein the composite film comprises a second light-emitting surface and a second bottom surface opposite to each other, the second bottom surface faces the first light-emitting surface of the structural optical film, and the composite film further comprises a plurality of second strip structures disposed on the second light-emitting surface and an anti-absorption layer disposed on the second bottom surface;
a brightening film, disposed on one side of the composite film adjacent to the second light-emitting surface, wherein the brightening film comprises a third light-emitting surface and a third bottom surface opposite to each other, the third bottom surface faces the second light-emitting surface of the composite film, and the brightening film further comprises a plurality of third strip structures disposed on the third light-emitting surface;
a light guide plate, disposed on one side of the structural optical film adjacent to the first bottom surface, wherein the light guide plate comprises a light incident surface, an upper surface, and a lower surface opposite to the upper surface, and the upper surface faces the first bottom surface of the structural optical surface; and
a plurality of light-emitting elements, disposed on one side of the light guide plate adjacent to the light incident surface, wherein the light-emitting elements are arranged along a light source arrangement direction.

2. The backlight module according to claim 1, wherein each of the first strip structures of the structural optical film extends along a first extension direction, and the first extension direction is not parallel to the light source arrangement direction.

3. The backlight module according to claim 2, wherein a first extension angle is defined between the first extension direction and the light source arrangement direction, and the first extension angle is between 60 degrees and 120 degrees.

4. The backlight module according to claim 2, wherein each of the second strip structures extends along a second extension direction, a second extension angle is defined between the first extension direction and the second extension direction, and the second extension angle is between 80 degrees and 100 degrees.

5. The backlight module according to claim 2, wherein each of the third strip structures extends along a third extension direction, a third extension angle is defined between the first extension direction and the third extension direction, and the third extension angle is between 0 degrees and 10 degrees.

6. The backlight module according to claim 1, wherein each of the first strip structures comprises two first side surfaces, a first structural angle is defined between the two first side surfaces, and the first structural angle is between 80 degrees and 110 degrees.

7. The backlight module according to claim 6, wherein each of the first strip structures further comprises a first top surface, the first top surface is connected to the two first side surfaces, and the first top surface is an arc surface.

8. The backlight module according to claim 1, wherein a cross-section of each of the first strip structures perpendicular to the first bottom surface is semi-elliptical, or alternatively, the cross-section of each of the first strip structures perpendicular to the first bottom surface has an edge line which is a parabola.

9. The backlight module according to claim 8, wherein when the cross-section of each of the first strip structures perpendicular to the first bottom surface is semi-elliptical, an edge of the cross-section conforms to the elliptical equation
$$1 = \frac{{( x - H )}^{2}}{{A}^{2}} + \frac{{( y - K )}^{2}}{{B}^{2}} ,$$
where A is the semi-major axis length, B is the semi-minor axis length, B is less than A, H represents an X-axis coordinate of the center of the ellipse, which is an intersection of the major axis and the minor axis in the X-Y plane, K represents the Y-axis coordinate of the center of the ellipse, x represents an X-axis coordinate of an arbitrary point on the elliptical perimeter, y represents the Y-axis coordinate of the arbitrary point, and y is greater than or equal to K, or greater than or equal to zero.

10. The backlight module according to claim 8, wherein when the edge line of the cross-section of each of the first strip structures perpendicular to the first bottom surface is a parabola, the edge line conforms to the parabolic equation
$${( x - h )}^{2} = 4 c ( y - k ) ,$$
where the axis of the symmetry of the parabola in the X-Y plane is x=h, the focus of the parabola is located at (h, k+c), h represents the X-axis coordinate of the vertex of the parabola in the X-Y plane, k represents the Y-axis coordinate of the vertex of the parabola in the X-Y plane, y is greater than or equal to 0, c is the focus length of the parabola, and the absolute value of c is greater than 0.1 μm and less than 5 μm.

11. The backlight module according to claim 1, wherein each of the first strip structures has a first strip structure height in a direction perpendicular to the first bottom surface, each of the optical diffusion structures has an optical diffusion structure height in the direction perpendicular to the first bottom surface, and the first strip structure height is greater than the optical diffusion structure height.

12. The backlight module according to claim 1, wherein each of the optical diffusion structures is a coating layer comprising a plurality of diffusion particles.

13. The backlight module according to claim 1, wherein each of the optical diffusion structures comprises a plurality of dot-shaped microstructures, each of the dot-shaped microstructures has a surface profile, and the surface profile is a spherical surface, an elliptical surface, or a free-form curved surface.

14. The backlight module according to claim 13, wherein the surface profile conforms to the equation
$$S ( x ) = \frac{{x}^{2}}{R + \sqrt{{R}^{2} - ( k + 1 ) {x}^{2}}} ,$$
where S(x) represents the surface profile of each of the dot-shaped microstructures in the X-axis, k represents a conic constant of each of the dot-shaped microstructures, k is greater than −1 and less than or equal to 0, R represents a radius of curvature at a vertex of each of the dot-shaped microstructures, R is between 0.05 μm and 0.2 μm, x represents an X-axis coordinate of the surface profile, and the dot-shaped microstructures have the same R value and the same k value.

15. The backlight module according to claim 1, wherein the optical diffusion structures collectively occupy between 5% and 50% of the overall area of the first bottom surface.

16. The backlight module according to claim 1, wherein the structural optical film further comprises a buffer layer, the buffer layer is disposed on the first light-emitting surface, and the buffer layer comprises a flexible optical adhesive.

17. The backlight module according to claim 1, wherein the light guide plate further comprises a plurality of light guide microstructures, and the light guide microstructures are disposed on the lower surface.

18. The backlight module according to claim 17, wherein each of the light guide microstructures comprises a backlight surface, a backlight angle is defined between the backlight surface and the lower surface, and the backlight angle is between 1 degree and 6 degrees.

19. The backlight module according to claim 17, wherein each of the light guide microstructures comprises a light-receiving surface, the light-receiving surface is a curved surface, a cross-section of each of the light guide microstructures perpendicular to the lower surface has a light-receiving ridge line, a light-receiving angle is defined between the light-receiving ridge line and the lower surface, and the light-receiving angle is between 1 degree and 20 degrees.

20. The backlight module according to claim 1, wherein each of the second strip structures comprises two second side surfaces, a second structural angle is defined between the two second side surfaces, and the second structural angle is between 80 degrees and 110 degrees.

21. The backlight module according to claim 20, wherein each of the second strip structures further comprises a second top surface, the second top surface is connected to the two second side surfaces, and the second top surface is an arc surface.

22. The backlight module according to claim 1, wherein a cross-section of each of the second strip structures perpendicular to the second light-emitting surface is semi-elliptical, or alternatively, the cross-section of each of the second strip structures perpendicular to the second light-emitting surface has an edge line which is a parabola.

23. The backlight module according to claim 22, wherein when the cross-section of each of the second strip structures perpendicular to the second light-emitting surface is semi-elliptical, an edge of the cross-section conforms to the elliptical equation
$$1 = \frac{{( x - H )}^{2}}{{A}^{2}} + \frac{{( y - K )}^{2}}{{B}^{2}} ,$$
where A is the semi-major axis length, B is the semi-minor axis length, B is less than A, H represents the X-axis coordinate of the center of the ellipse, which is an intersection of the major axis and the minor axis in the X-Y plane, K represents the Y-axis coordinate of the center of the ellipse, x represents an X-axis coordinate of an arbitrary point on the elliptical perimeter, y represents the Y-axis coordinate of the arbitrary point, and y is greater than or equal to K, or greater than or equal to zero.

24. The backlight module according to claim 22, wherein when the edge line of the cross-section of each of the second strip structures perpendicular to the second light-emitting surface is a parabola, the edge line conforms to the parabolic equation
$${( x - h )}^{2} = 4 c ( y - k ) ,$$
where the axis of the symmetry of the parabola in the X-Y plane is x=h, the focus of the parabola is located at (h, k+c), h represents the X-axis coordinate of the vertex of the parabola in the X-Y plane, k represents the Y-axis coordinate of the vertex of the parabola in the X-Y plane, y is greater than or equal to 0, c is the focus length of the parabola, and the absolute value of c is greater than 0.1 μm and less than 5 μm.

25. The backlight module according to claim 1, wherein the anti-absorption structure comprises a plurality of dot-shaped microstructures, each of the dot-shaped structures has a surface profile, and the surface profile is a spherical surface, an elliptical surface, or a free-form curved surface.

26. The backlight module according to claim 25, wherein the surface profile conforms to the equation
$$S ( x ) = \frac{{x}^{2}}{R + \sqrt{{R}^{2} - ( k + 1 ) {x}^{2}}} ,$$
where S(x) represents the surface profile of each of the dot-shaped microstructures in the X-axis, k represents a conic constant of each of the dot-shaped microstructures, k is greater than −1 and less than or equal to 0, R represents a radius of curvature at a vertex of each of the dot-shaped microstructures, R is between 0.005 μm and 0.05 μm, x represents an X-axis coordinate of the surface profile, and the dot-shaped microstructures have the same R value and the same k value.

27. The backlight module according to claim 1, wherein the anti-absorption structure is a coating layer comprising a plurality of diffusion particles.

28. The backlight module according to claim 1, wherein each of the third strip structures comprises two third side surfaces, a third structural angle is defined between the two third side surfaces, and the third structural angle is between 80 degrees and 110 degrees.

29. The backlight module according to claim 28, wherein each of the third strip structures further comprises a third top surface, the third top surface is connected to the two third side surfaces, and the third top surface is an arc surface.

30. The backlight module according to claim 1, wherein a cross-section of each of the third strip structures perpendicular to the third light-emitting surface is semi-elliptical, or alternatively, the cross-section of each of the third strip structures perpendicular to the third light-emitting surface has an edge line which is a parabola.

31. The backlight module according to claim 30, wherein when the cross-section of each of the third strip structures perpendicular to the third light-emitting surface is semi-elliptical, an edge of the cross-section conforms to the elliptical equation
$$1 = \frac{{( x - H )}^{2}}{{A}^{2}} + \frac{{( y - K )}^{2}}{{B}^{2}} ,$$
where A is the semi-major axis length, B is the semi-minor axis length, B is less than A, H represents the X-axis coordinate of the center of the ellipse, which is an intersection of the major axis and the minor axis in the X-Y plane, K represents the Y-axis coordinate of the center of the ellipse, x represents an X-axis coordinate of an arbitrary point on the elliptical perimeter, y represents the Y-axis coordinate of the arbitrary point, and y is greater than or equal to K, or is greater than or equal to zero.

32. The backlight module according to claim 30, wherein when the edge line of the cross-section of each of the second strip structures perpendicular to the second light-emitting surface is a parabola, the edge line conforms to the parabolic equation
$${( x - h )}^{2} = 4 c ( y - k ) ,$$
where the axis of the symmetry of the parabola in the X-Y plane is x=h, the focus of the parabola is located at (h, k+c), h represents the X-axis coordinate of the vertex of the parabola in the X-Y plane, k represents the Y-axis coordinate of the vertex of the parabola in the X-Y plane, y is greater than or equal to 0, c is the focus length of the parabola, and the absolute value of c is greater than 0.1 μm and less than 5 μm.

33. The backlight module according to claim 1, further comprising a reflective sheet and at least one optical film, wherein the reflective sheet is disposed on one side of the light guide plate adjacent to the lower surface, the at least one optical film is disposed on one side of the structural optical film away from the light guide plate, and the optical film comprises a diffusion sheet or a reflective brightening film.

34. A structural optical film, comprising:
a structural optical body, comprising a first light-emitting surface and a first bottom surface opposite to each other; and
a structural layer, disposed on the first bottom surface, wherein the structural layer comprises a plurality of first strip structures and a plurality of optical diffusion structures, the first strip structures are arranged at intervals, and the optical diffusion structures are respectively disposed between the first strip structures.

35. The structural optical film according to claim 34, wherein each of the first strip structures comprises two first side surfaces, a first structural angle is defined between the two first side surfaces, and the first structural angle is between 80 degrees and 110 degrees.

36. The structural optical film according to claim 35, wherein each of the first strip structures further comprises a first top surface, the first top surface is connected to the two first side surfaces, and the first top surface is an arc surface.

37. The structural optical film according to claim 34, wherein a cross-section of each of the first strip structures perpendicular to the first bottom surface is semi-elliptical, or alternatively, the cross-section of each of the first strip structures perpendicular to the first bottom surface has an edge line which is parabola.

38. The structural optical film according to claim 37, wherein when the cross-section of each of the first strip structures perpendicular to the first bottom surface is semi-elliptical, an edge of the cross-section conforms to the elliptical equation
$$1 = \frac{{( x - H )}^{2}}{{A}^{2}} + \frac{{( y - K )}^{2}}{{B}^{2}} ,$$
where A is the semi-major axis length, B is the semi-minor axis length, B is less than A, H represents the X-axis coordinate of the center of the ellipse, which is an intersection of the major axis and the minor axis in the X-Y plane, K represents the Y-axis coordinate of the center of the ellipse, x represents an X-axis coordinate of an arbitrary point on the elliptical perimeter, y represents the Y-axis coordinate of the arbitrary point, and y is greater than or equal to K, or is greater than or equal to zero.

39. The structural optical film according to claim 37, wherein when the edge line of the cross-section of each of the first strip structures perpendicular to the first bottom surface is a parabola, the edge line conforms to the parabolic equation
$${( x - h )}^{2} = 4 c ( y - k ) ,$$
where the axis of the symmetry of the parabola in the X-Y plane is x=h, the focus of the parabola is located at (h, k+c), h represents the X-axis coordinate of the vertex of the parabola in the X-Y plane, k represents the Y-axis coordinate of the vertex of the parabola in the X-Y plane, y is greater than or equal to 0, c is the focus length of the parabola, and the absolute value of c is greater than 0.1 μm and less than 5 μm.

40. The structural optical film according to claim 34, wherein each of the first strip structures has a first strip structure height in a direction perpendicular to the first bottom surface, each of the optical diffusion structures has an optical diffusion structure height in the direction perpendicular to the first bottom surface, and the first strip structure height is greater than the optical diffusion structure height.

41. The structural optical film according to claim 34, wherein each of the optical diffusion structures is a coating layer comprising a plurality of diffusion particles.

42. The structural optical film according to claim 34, wherein each of the optical diffusion structures comprises a plurality of dot-shaped microstructures, each of the dot-shaped structures has a surface profile, and the surface profile is a spherical surface, an elliptical surface, or a free-form curved surface.
